(19) United States
(12) Patent Application Publication
(10) Pub. No.: US 2023/0013717 A1
(43) Pub. Date: Jan. 19, 2023

(54) POLYPROPYLENE COMPOSITION, PREPARATION METHOD AND USE THEREOF

(71) Applicant: KINGFA SCI. & TECH. CO., LTD., Guangdong (CN)

(72) Inventors: Juanxia SU, Guangdong (CN); Bo YANG, Guangdong (CN); Xianbo HUANG, Guangdong (CN); Nanbiao YE, Guangdong (CN); Liang LEI, Guangdong (CN); Li PENG, Guangdong (CN); Chaoliang LU, Guangdong (CN); Yezhong CHEN, Guangdong (CN); Zhongfu LUO, Guangdong (CN); Zhengya DING, Guangdong (CN)

(73) Assignee: KINGFA SCI. & TECH. CO., LTD., Guangdong (CN)

(21) Appl. No.: 17/784,672

(22) PCT Filed: Oct. 27, 2020
(86) PCT No.: PCT/CN2020/124014

§ 371 Date: Jun. 13, 2022

(30) Foreign Application Priority Data
Dec. 17, 2019 (CN) 201911303504.X

(51) Int. Cl. C08L 23/12; C08L 23/08; C08L 83/10; B29C 48/40

(52) U.S. Cl. CPC C08L 23/12; C08L 23/0815; C08L 83/10; B29C 48/40; B29K 2023/12

(57) ABSTRACT

A polypropylene composition comprising the following components in parts by weight: 40-99 parts of a polypropylene resin; 15-30 parts of an ethylene-α olefin copolymer; 0.2-1 part of an antimicrobial agent; and 1-3 parts of a polypropylene grafted polydimethylsiloxane is provided. By controlling a melt index of an elastomer, distribution of the modified polydimethylsiloxane and antimicrobial agent can be improved, thus improving antimicrobial and stain-resistant effects of the polypropylene composition.

### TECHNICAL FIELD

The invention relates to the technical field of polymer materials, and in particular relates to a polypropylene composition, a preparation method and a use thereof.

### DESCRIPTION OF RELATED ART

Compared with other general-purpose plastics, polypropylene has advantages of good mechanical properties, low density, good rigidity, high strength and good electrical insulation properties, and is widely used in home appliances and automotive products. When modified polypropylene is used in washing machines and small household appliances, when used for too long, the polypropylene material is easily stained, and bacteria and mold grow at the same time, which limits the application scope of the polypropylene material. In the field of automotive applications, when the vehicle is in use, cosmetics and food of driver and passengers are easy to stain the interior materials, and some of the dirt is difficult to clean. With a promotion of new travel modes (car sharing/online car-hailing), there is a demand for antimicrobial and stain-resistant properties of automotive materials.

Chinese patent application CN 106117802 B discloses a powdered ore enhanced polypropylene composition and a preparation method thereof. In formula of the powdered ore enhanced polypropylene composition, it is added with a specific content of an interface modifier (epoxy siloxane coupling agent), a high-hydrophobicity auxiliary and an antimicrobial agent, a surface polarity of the powdered ore enhanced polypropylene composition is changed, a hydrophobic property of the powdered ore enhanced polypropylene composition is improved, and antimicrobial and mildew-resistant properties of the powdered ore enhanced polypropylene composition is improved. Chinese patent application CN109294149A discloses a durable antimicrobial polypropylene plastic cup. A preparation method of the plastic cup is mainly by adding polydimethylsiloxane as a stain-resistant agent, however due to its insufficient dispersibility in the polypropylene resin matrix, ethylene bis stearamide needs to be added to assist.

Chinese patent application CN101591443A discloses a polypropylene grafted modified additive with water affinity and the organism affinity, wherein a segmer with water affinity and organism affinity may be polydimethylsiloxane. The modified additive has excellent adhesion with the polypropylene, and can improve surface anticoagulation and other biocompatibility properties of the polypropylene. However, a compatibility of polypropylene grafted polydimethylsiloxane with polypropylene is not discussed.

### SUMMARY

An objective of the present invention is to provide a polypropylene composition with good antimicrobial effect and stain-resistant effect.

Another objective of the present invention is to provide a preparation method and a use of the above polypropylene composition.

The present invention is achieved through the following technical solutions.

A polypropylene composition, in parts by weight, includes the following components:
40-99 parts of a polypropylene resin;
15-30 parts of an ethylene-α olefin copolymer;
0.2-1 part of an antimicrobial agent; and
1-3 parts of a polypropylene grafted polydimethylsiloxane.

Preferably, in parts by weight, an amount of the antimicrobial agent is 0.2-0.4 parts. Under the resin matrix of the present invention, the amount of the antimicrobial agent can be greatly reduced.

The ethylene-α olefin copolymer is selected from at least one of ethylene-propylene copolymer, ethylene-hexene copolymer, ethylene-butene copolymer and ethylene-octene copolymer.

Generally, thermoplastic elastomers used in polypropylene include styrenes (including SBS, SIS, SEBS, and SEPS), polyolefins (mainly ethylene-α olefin copolymers), PP/EPDM blends, OBC and the like. Styrenics, PP/EPDM blends, and OBC cannot achieve the objectives of the present invention.

Preferably, a melt index of the ethylene-α olefin copolymer is 5-30 g/10 min (190° C., 2.16 kg).

The antimicrobial agent is selected from at least one of zinc oxide, zeolite supported silver ion or glass-based supported silver ion.

Preferably, the polypropylene grafted polydimethylsiloxane has a grafting ratio of 60%-80% and a molecular weight of 600,000-800,000. The addition of polypropylene grafted polydimethylsiloxane can be enriched on surface of the material, which has a stain-resistant effect, reduce water residue and also can destroy growth environment of bacteria and improve an antimicrobial effect.

Polypropylene is a crystalline resin, and the antimicrobial agent is discharged outside a crystalline region and mainly distributed in an amorphous region during crystallization process of polypropylene. It finds in the present invention that by adding a certain amount of ethylene-α olefin copolymer with a high-melting index to polypropylene resin, it can be better deformed, broken and dispersed uniformly under a shearing action. Especially for a surface layer, a highly oriented and remarkable filamentous network structure is formed due to high shear during the injection molding process, which can increase exposure of a surface layer antimicrobial agent to enhance an antimicrobial effect.

Polysiloxane has a low surface tension and a good hydrophobic property. If enriched on the surface of the material, a stain-resistant property of the surface can be improved, such as shoe polish wiping property involved in this experiment. At the same time, due to its hydrophobic property, a surface layer of the material is more difficult to absorb water molecules in the air to form a water film, which has a certain effect on inhibiting growth of bacteria. However, enrichment of polysiloxane on the surface would destroy a filamentous network structure, which in turn reduces an antimicrobial property. Therefore, the present invention adopts polypropylene grafted polydimethylsiloxane, which is enriched on the surface without destroying the filamentous network structure, ensuring good stain-resistant effect and bactericidal effect and under a synergistic effect, obtaining an excellent antimicrobial property.

A certain amount of a filler may further be added to the composition of the present invention to improve other properties, in parts by weight, 0-30 parts of a filler is further included; the filler is selected from at least one of talc, calcium carbonate, wollastonite, barium sulfate, mica, microsilica, silicon dioxide, magnesium hydroxide and montmorillonite.

In the present invention, a particle size of the filler is not particularly limited.

In order to improve processing property or obtain other properties, in parts by weight, 0-10 parts of an auxiliary agent is further included; the auxiliary agent is selected from at least one of a lubricant and a color powder.

The lubricants may be: stearates and amides, such as zinc stearate, calcium stearate, ethylene bis-stearate amide and the like.

The color powder may be: titanium white, carbon black, phthalocyanine blue, iron red, titanium yellow and the like.

A preparation method of the above-mentioned polypropylene composition is weighing each component according to a weight ratio, adding to a high-speed mixer and mixing for 1-3 minutes with a rotating speed being 1,000-2,000 rpm, to obtain a premix; melting and extruding the premix through a twin-screw extruder, with a temperature of each zone of the screw being 190-230° C., and granulating in vacuum to obtain a product.

A use of the above-mentioned polypropylene composition is used in automotive interior parts such as instrument panels, sub-instrument panels, uprights, glove boxes, door panels, door sills, and air conditioner housings.

The present invention has the following beneficial effects.

In the present invention an antimicrobial system of ethylene-α olefin copolymer and polypropylene grafted polydimethylsiloxane is adopted, and a highly oriented and remarkable filamentary network structure due to high shearing during the injection molding process is formed, which can improve exposure of a surface layer antimicrobial agent, to enhance an antimicrobial effect, in synergy with a stain-resistant property after the polypropylene grafted polydimethylsiloxane enriched on the surface, a polypropylene composition with a good antimicrobial effect can be obtained under a low addition amount of the antimicrobial agent.

### BRIEF DESCRIPTION OF THE DRAWINGS

FIG. 1: an electron micrograph of surface of material with a filamentous network structure.

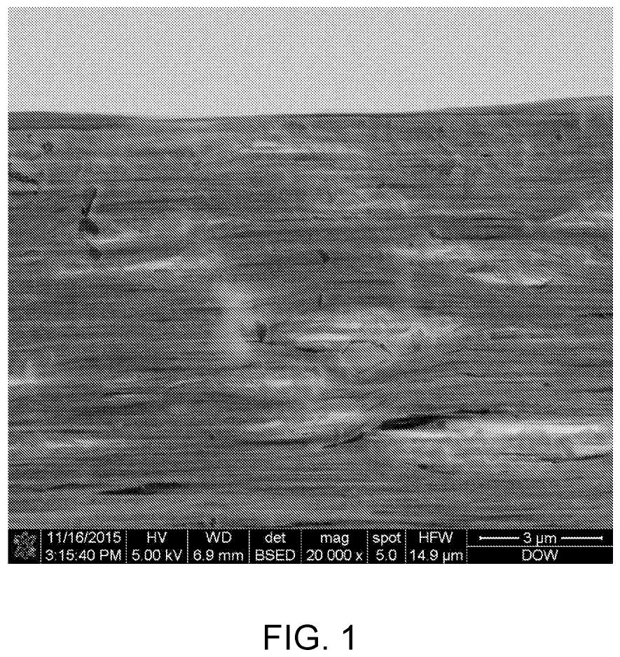

FIG. 2: an electron micrograph of surface of material without a filamentous network structure.

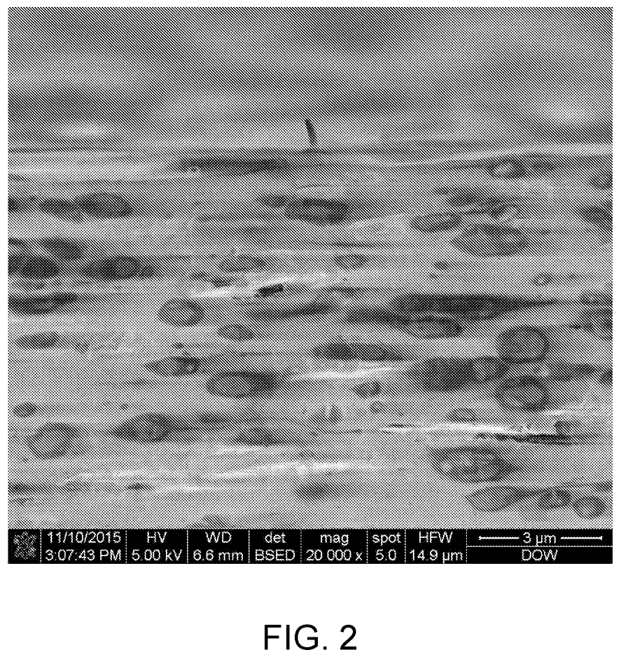

### DESCRIPTION OF THE EMBODIMENTS

The present invention will be further described below through specific implementations. The following embodiments are preferred implementations of the present invention, but the implementations of the present invention are not limited by the following embodiments.

Raw materials used in the present invention are as follows:
Polypropylene: N-Z30S;
Antimicrobial agent: silver ion antimicrobial agent BM-502FA, glass carrier;
Ethylene-octene copolymer, melt index of 8 g/10 min (190° C., 2.16 kg), POE 8137;
Ethylene-butene copolymer, melt index of 5 g/10 min (190° C., 2.16 kg), grade POE LC565;
SEBS, melt index of 10 g/10 min (230° C., 2.16 kg), G1657 MS;
OBC, melt index of 5 g/10 min (190° C., 2.16 kg), Infuse 9507;
Polypropylene grafted polydimethylsiloxane A: grafting ratio of 63%, and molecular weight of about 680,000;
Polypropylene grafted polydimethylsiloxane B: grafting ratio of 78%, and molecular weight of about 760,000;
Polypropylene grafted polydimethylsiloxane C: grafting ratio of 43%, and molecular weight of about 570,000;
Polydimethylsiloxane: TP-200, molecular weight of about 600,000;
Talc: TYT-777A;
Lubricant: zinc stearate; BS-2818;
Color powder: carbon black; M717.

A preparation method of polypropylene composition of Embodiments and Comparative Examples: weighing each component according to a weight ratio, adding to a high-speed mixer and mixing for 1-3 minutes with a rotating speed being 1,000-2,000 rpm, to obtain a premix; melting and extruding the premix through a twin-screw extruder, with a temperature of each zone of the screw being 190-230° C., and granulating in vacuum to obtain the polypropylene composition.

### Various Property Test Methods

The polypropylene composition was injection molded into a 100 cm*100 cm*3 mm square plate in an injection molding machine, and a stain-resistant property and an antimicrobial property of sample surface were tested.

(1) Stain-resistant property test: 2 drops of LAORENTOU liquid shoe polish are dropped on the sample surface, after dried at room temperature for 24 hours, wiped with gauze and it is evaluated as follows: completely wiped without leaving traces is grade 3; partially wiped is grade 2; completely not wiped is grade 1.

(2) Antimicrobial property test: According to JIS Z 2801:2012, it is evaluated as follows: obvious bacteriostasis is A, general bacteriostasis is B, and no bacteriostasis is C.

TABLE 1
Distribution ratio (in parts by weight) of each component of the polypropylene composition of Embodiments and test results of various properties

| | Embodiment 1 | Embodiment 2 | Embodiment 3 | Embodiment 4 | Embodiment 5 | Embodiment 6 | Embodiment 7 |
|---|---|---|---|---|---|---|---|
| Polypropylene | 80 | 80 | 80 | 80 | 80 | 80 | 80 |
| Antimicrobial agent | 0.2 | 0.2 | 0.2 | 0.4 | 1 | 0.2 | 0.2 |
| Ethylene-octene copolymer | 20 | | 20 | 20 | 20 | 15 | 30 |
| Ethylene-butene copolymer | | 20 | | | | | |
| Polypropylene grafted | 1 | | | 1 | 1 | 2 | 3 |
| polydimethylsiloxane A | | | | | | | |
| Polypropylene grafted | | 1 | | | | | |
| polydimethylsiloxane B | | | | | | | |
| Polypropylene grafted | | | 1 | | | | |
| polydimethylsiloxane C | | | | | | | |
| Talc | 15 | 15 | 15 | 15 | 15 | 15 | 15 |
| Lubricant | 0.2 | 0.2 | 0.2 | 0.2 | 0.2 | 0.2 | 0.2 |
| Color powder | 0.5 | 0.5 | 0.5 | 0.5 | 0.5 | 0.5 | 0.5 |
| Stain-resistant property | 3 | 3 | 2 | 3 | 3 | 3 | 3 |
| Antimicrobial property | A | A | B | A | A | A | A |

It can be seen from Embodiments 1-3 that the grafting ratio of polypropylene grafted polydimethylsiloxane also affects a formation of filamentous network structure on the surface of the material. Within a preferred range of the grafting ratio, an antimicrobial effect is better.

TABLE 2
Distribution ratio (in parts by weight) of each component of the polypropylene
composition of Comparative Examples and test results of various properties

| | Comparative | Comparative | Comparative | Comparative | Comparative | Comparative |
|---|---|---|---|---|---|---|
| | Example 1 | Example 2 | Example 3 | Example 4 | Example 5 | Example 6 |
| Polypropylene | 80 | 80 | 80 | 80 | 80 | 80 |
| Antimicrobial agent | 0.2 | 0.2 | 0.2 | 0.2 | 0.2 | 0.2 |
| Ethylene-octene copolymer | | | 20 | 20 | | 10 |
| SEBS | 20 | | | | 20 | |
| OBC | | 20 | | | | |
| Polypropylene grafted | 1 | 1 | | | | 1 |
| polydimethylsiloxane A | | | | | | |
| Polydimethylsiloxane | | | 1 | 2 | 1 | |
| Talc | 15 | 15 | 15 | 15 | 15 | 15 |
| Lubricant | 0.2 | 0.2 | 0.2 | 0.2 | 0.2 | 0.2 |
| Color powder | 0.5 | 0.5 | 0.5 | 0.5 | 0.5 | 0.5 |
| Stain-resistant property | 2 | 2 | 2 | 3 | 1 | 2 |
| Antimicrobial property | C | C | C | C | C | C |

| | Comparative | Comparative |
|---|---|---|
| | Example 7 | Example 8 |
| Polypropylene | 80 | 80 |
| Antimicrobial agent | 0.2 | 0.2 |
| Ethylene-octene copolymer | 20 | 20 |
| SEBS | | |
| OBC | | |
| Polypropylene grafted | 0.3 | 5 |
| polydimethylsiloxane A | | |
| Polydimethylsiloxane | | |
| Talc | 15 | 15 |
| Lubricant | 0.2 | 0.2 |
| Color powder | 0.5 | 0.5 |
| Stain-resistant property | 1 | 3 |
| Antimicrobial property | C | C |

It can be seen from Comparative Example 1 or 2 or 5 that other types of elastomers cannot make the surface of the material have a significant filamentary network structure, so an antimicrobial effect is poor.

It can be seen from Comparative Example 3 or 4 that the polydimethylsiloxane without polypropylene grafted can obtain a good stain-resistant property by increasing an amount, but the antimicrobial property is very poor.

It can be seen from Comparative Example 6 that the amount of ethylene-α olefin copolymer will also affect formation of the filamentous network structure on the surface of the material and thus affect a bactericidal effect of the antimicrobial agent.

It can be seen from Comparative Example 7 or 8 that the amount of polypropylene grafted polydimethylsiloxane is too low, the surface of the material has a poor stain-resistant property, bacteria are easy to grow, and the antimicrobial property is comprehensively reduced. If the amount of polypropylene grafted polydimethylsiloxane is too high, it is easy to destroy the filamentous network structure on the surface of the material, instead reducing the antimicrobial property.

1. A polypropylene composition, in parts by weight, comprising the following components:
40-99 parts of a polypropylene resin;
15-30 parts of an ethylene-α olefin copolymer;
0.2-1 part of an antimicrobial agent; and
1-3 parts of a polypropylene grafted polydimethylsiloxane.

2. The polypropylene composition according to claim 1, wherein in parts by weight, an amount of the antimicrobial agent is 0.2-0.4 parts.

3. The polypropylene composition according to claim 1, wherein the ethylene-α olefin copolymer is selected from at least one of ethylene-propylene copolymer, ethylene-hexene copolymer, ethylene-butene copolymer and ethylene-octene copolymer.

4. The polypropylene composition according to claim 3, wherein a melt index of the ethylene-α olefin copolymer is 5-30 g/10 min (190° C., 2.16 kg).

5. The polypropylene composition according to claim 1, wherein the antimicrobial agent is selected from at least one of zinc oxide, zeolite supported silver ion or glass-based supported silver ion.

6. The polypropylene composition according to claim 1, wherein the polypropylene grafted polydimethylsiloxane has a grafting ratio of 60%-80% and a molecular weight of 600,000-800,000.

7. The polypropylene composition according to claim 1, wherein in parts by weight, further comprising 0-30 parts of a filler; the filler is selected from at least one of talc, calcium carbonate, wollastonite, barium sulfate, mica, microsilica, silicon dioxide, magnesium hydroxide and montmorillonite.

8. The polypropylene composition according to claim 1, wherein in parts by weight, further comprising 0-10 parts of an auxiliary agent; the auxiliary agent is selected from at least one of a lubricant and a color powder.

9. A preparation method of the polypropylene composition of claim 1, is weighing each component according to a weight ratio, adding to a high-speed mixer and mixing for 1-3 minutes with a rotating speed being 1,000-2,000 rpm, to obtain a premix; melting and extruding the premix through a twin-screw extruder, with a temperature of each zone of the screw being 190-230° C., and granulating in vacuum to obtain the polypropylene composition.

10. Use of the polypropylene composition according to claim 1, wherein the polypropylene composition is used in applications of instrument panels, sub-instrument panels, uprights, glove boxes, door panels, door sills, air conditioner housings, and other automotive interior parts.

11. A preparation method of the polypropylene composition of claim 2, is weighing each component according to a weight ratio, adding to a high-speed mixer and mixing for 1-3 minutes with a rotating speed being 1,000-2,000 rpm, to obtain a premix; melting and extruding the premix through a twin-screw extruder, with a temperature of each zone of the screw being 190-230° C., and granulating in vacuum to obtain the polypropylene composition.

12. A preparation method of the polypropylene composition of claim 3, is weighing each component according to a weight ratio, adding to a high-speed mixer and mixing for 1-3 minutes with a rotating speed being 1,000-2,000 rpm, to obtain a premix; melting and extruding the premix through a twin-screw extruder, with a temperature of each zone of the screw being 190-230° C., and granulating in vacuum to obtain the polypropylene composition.

13. A preparation method of the polypropylene composition of claim 4, is weighing each component according to a weight ratio, adding to a high-speed mixer and mixing for 1-3 minutes with a rotating speed being 1,000-2,000 rpm, to obtain a premix; melting and extruding the premix through a twin-screw extruder, with a temperature of each zone of the screw being 190-230° C., and granulating in vacuum to obtain the polypropylene composition.

14. A preparation method of the polypropylene composition of claim 5, is weighing each component according to a weight ratio, adding to a high-speed mixer and mixing for 1-3 minutes with a rotating speed being 1,000-2,000 rpm, to obtain a premix; melting and extruding the premix through a twin-screw extruder, with a temperature of each zone of the screw being 190-230° C., and granulating in vacuum to obtain the polypropylene composition.

15. A preparation method of the polypropylene composition of claim 6, is weighing each component according to a weight ratio, adding to a high-speed mixer and mixing for 1-3 minutes with a rotating speed being 1,000-2,000 rpm, to obtain a premix; melting and extruding the premix through a twin-screw extruder, with a temperature of each zone of the screw being 190-230° C., and granulating in vacuum to obtain the polypropylene composition.

16. A preparation method of the polypropylene composition of claim 7, is weighing each component according to a weight ratio, adding to a high-speed mixer and mixing for 1-3 minutes with a rotating speed being 1,000-2,000 rpm, to obtain a premix; melting and extruding the premix through a twin-screw extruder, with a temperature of each zone of the screw being 190-230° C., and granulating in vacuum to obtain the polypropylene composition.

17. A preparation method of the polypropylene composition of claim 8, is weighing each component according to a weight ratio, adding to a high-speed mixer and mixing for 1-3 minutes with a rotating speed being 1,000-2,000 rpm, to obtain a premix; melting and extruding the premix through a twin-screw extruder, with a temperature of each zone of the screw being 190-230° C., and granulating in vacuum to obtain the polypropylene composition.
